(19) United States
(12) Patent Application Publication
(10) Pub. No.: US 2013/0078861 A1
(43) Pub. Date: Mar. 28, 2013

(54) LIVE WIREOUTDOOR SOCKET WITH LAMP

(71) Applicant: Chi Wen Cheng, Dong Guan City (CN)

(72) Inventor: Chi Wen Cheng, Dong Guan City (CN)

(21) Appl. No.: 13/240,941

(22) Filed: Sep. 22, 2011

(51) Int. Cl. H01R 13/717

(52) U.S. Cl. 439/620.02

(57) ABSTRACT

An outdoor socket with lamp includes a main body, a live wire terminal, a neutral wire terminal, an LED illumination unit, a transformer, an outer casing, and a switch. Through two insertion portions at the front side of the main body, the LED illumination unit is vertically inserted in a fixing trough. The present invention provides a better waterproof effect, which can be used outdoors. The light of the LED illumination unit illuminates forward, providing an illumination effect. The fixing trough is disposed between the two adjacent insertion portions, which saves space and is compact.

### BACKGROUND OF THE INVENTION

1. Field of the Invention

The present invention relates to a power source socket, and more particularly to an outdoor socket with lamp to provide an illumination effect.

2. Description of the Prior Art

A conventional socket comprises at least one base to connect the wiring of other circuit. The socket is a power source interface for electric appliances, which is also an essential electric accessory.

There are various sockets on the market. These sockets mainly comprise an insulation base and terminals (a live wire terminal, a neutral wire terminal and an earth terminal) in the insulation base. The insulation base has insertion holes thereon. The terminals are located in the insertion holes. When in use, the feet of a plug are inserted into the insertion holes to electrically connect with the relative terminals.

The insertion holes of most sockets are disposed on the upper surfaces of the insulation base, which doesn't have a waterproof effect and is not adapted for outdoor activities. The conventional socket doesn't have an illumination effect, so it is difficult to look for the insertion holes at a dark environment. A flashlight is required to look for the insertion holes. It is inconvenient to be used outdoors. Outdoor activities are more and more popular, so people need a socket adapted for outdoor activities. Accordingly, the inventor of the present invention has devoted himself based on his many years of practical experiences to solve these problems.

### SUMMARY OF THE INVENTION

The primary object of the present invention is to provide an outdoor socket with lamp to solve the problems of the conventional socket which doesn't have waterproof and illumination effects and is not convenient for outdoor activities.

In order to achieve the aforesaid object, the outdoor socket with lamp of the present invention comprises a main body, at least one live wire terminal, at least one neutral wire terminal, at least one LED (light emitting diode)neutral wire illumination unit, a transformer, an outer casing, and a switch.

The main body comprises a base, an upper lid and a lower lid. The base has an upper chamber and a lower chamber on upper and lower sides thereof. The upper lid and the lower lid are adapted to cover the upper chamber and the lower chamber, respectively. The main body has at least two insertion portions at a front side thereof. Each insertion portion has a first hole and a second hole. The first hole communicates with the upper chamber. The second hole communicates with the lower chamber. The main body further has a fixing trough which is vertically disposed at the front side of the main body and located between the insertion portions.

The live wire terminal is secured in the upper chamber. The live wire terminal has a first contact portion. The first contact portion is located in the first hole.

The neutral wire terminal is secured in the lower chamber. The neutral wire is terminal has a second contact portion. The second contact portion is located in the second hole.

The LED illumination unit comprises a circuit board and at least one LED disposed on the circuit board. The circuit board is vertically inserted into the fixing trough. The LED extends out of the fixing trough to illuminate forward.

The transformer is secured on the main body.

The outer casing wraps the main body. The outer casing has a first insertion hole and a second insertion hole. The first insertion hole and the second insertion hole respectively correspond in position to the first hole and the second hole.

The switch is used to control the LED illumination unit to be turned on/off. The switch is secured on the main body. The switch, the LED illumination unit and the transformer are in a series connection. The switch comprises an operation end which is exposed out of a surface of a rear end of the outer casing.

Compared to the prior art, the present invention has the following advantages.

Through the two insertion portions at the front side of the main body and the fixing trough which is vertically disposed between two adjacent insertion portions, the LED illumination unit is vertically inserted in the fixing trough instead of the traditional way that the insertion hole is disposed on the upper surface of an insulation base. The present invention provides a better waterproof effect, which can be used outdoors. The light of the LED illumination unit illuminates forward, providing an illumination effect and being convenient for outdoor activities. The fixing trough is disposed between the two adjacent insertion portions, which saves space and is compact and is convenient for installation and use.

Through the main body in a fan shape, the appearance of the present invention is beautiful. The product can be placed steadily, and the raw material can be saved to lower the manufacturing cost to be beneficial for market competition.

Through the first fixing portion of the live wire terminal in a curved-plate shape, the first connection portion protrudes from the inner side of the first fixing portion and the first contact portions protrude from the outer side of the first fixing portion to be one-piece. It is convenient to be assembled. The configuration of the neutral wire terminal and the earth terminal is similar to the live wire terminal, which is beneficial for the assembly efficiency.

Through the outer casing made of a transparent material, the light of the LED illumination unit can pass the outer casing to illuminate forward. The main body and the LED illumination unit are wrapped by the outer casing to protect all the parts in the main body. The outer casing is waterproof and durable to extend the span life of the product.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is another exploded view according to the preferred embodiment of the present invention;

FIG. 4 is a partial assembled view according to the preferred embodiment of the present invention;

FIG. 5 is another partial assembled view according to the preferred embodiment of the present invention; and

FIG. 6 is a schematic view showing the circuit of the preferred embodiment of the present invention.

### DETAILED DESCRIPTION OF THE PREFERRED EMBODIMENTS

Embodiments of the present invention will now be described, by way of example only, with reference to the accompanying drawings.

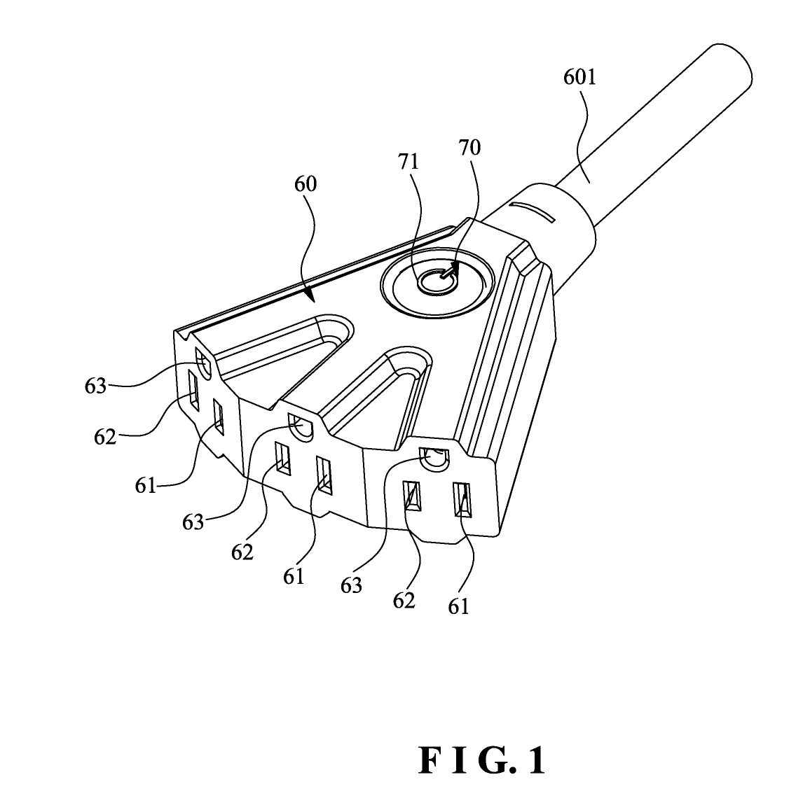

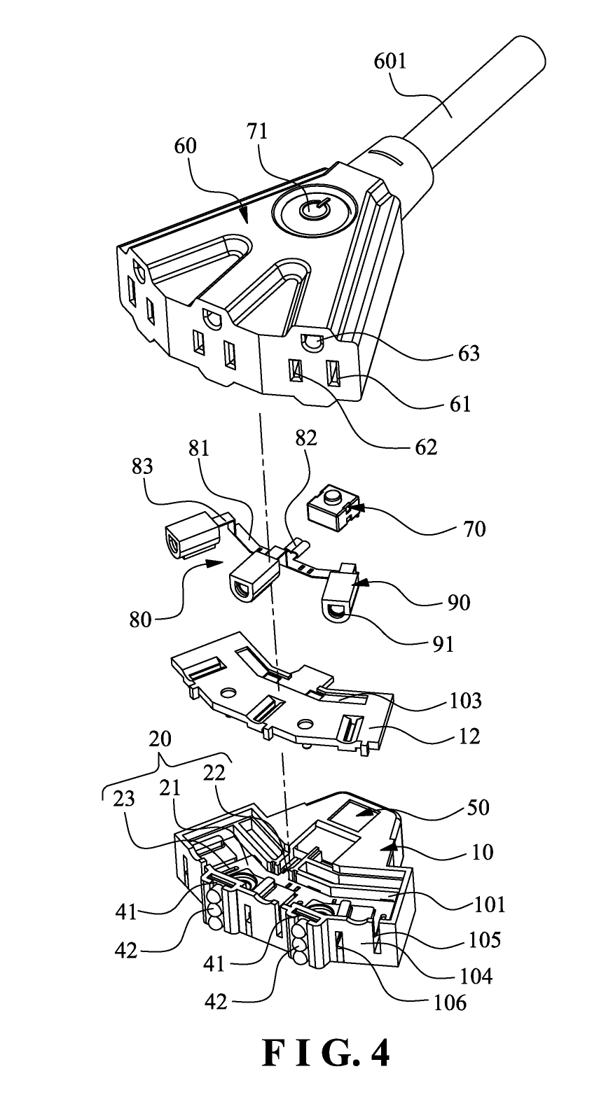

As shown in FIG. 1 through FIG. 6, the outdoor socket with lamp according to a first embodiment of the present invention comprises a main body 10, a live wire terminal 20, a neutral wire terminal 30, an LED (light emitting diode) illumination unit 40, a transformer 50, an outer casing 60, and a switch 70.

The main body 10 is in a fan shape and comprises a base 11, an upper lid 12 and a lower lid 13. The base 11 has an upper chamber 101 and a lower chamber 102 on upper and lower sides thereof. The upper chamber 101 and the lower is chamber 102 are in a fan-shaped configuration. The upper lid 12 and the lower lid 13 are fan-shaped plates. The upper lid 12 and the lower lid 13 are used to cover the upper chamber 101 and the lower chamber 102, respectively. The upper lid 12 has an insertion recess 103 on the upper surface of the inner side thereof. The main body 10 has two insertion portions 104 at a front side thereof. There are three insertion portions 104 in this embodiment. Each insertion portion 104 has a first hole 105 and a second hole 106. The first hole 105 communicates with the upper chamber 101. The second hole 106 communicates with the lower chamber 102. The main body 10 further has a fixing trough 107 which is vertically disposed at the front side of the main body 10 and located between two adjacent insertion portions 104. In this embodiment, the main body 10 has two fixing troughs 107.

The live wire terminal 20 is secured in the upper chamber 101. The live wire terminal 20 includes a first fixing portion 21, a first connection portion 22 and a plurality of first contact portions 23. The first fixing portion 21 is a curved plate. The first connection portion 22 protrudes from an inner side of the first fixing portion 21. The first connection portion 22 is used to connect an external live wire. The first contact portions 23 protrude from an outer side of the first fixing portion 21 and are spaced each other. The first contact portions 23 are respectively located in the first holes 105 of the insertion portions 104. Each first contact portion 23 includes two first arms 231 and a first groove 201 defined between the two first arms 231. The first groove 201 has a front opening facing the first hole 105. The feet of an external plug are inserted through the first hole 105 and into the first groove 201, so that the feet of the external plug are electrically connected.

The neutral wire terminal 30 is secured in the lower chamber 102. The neutral wire terminal 30 includes a second fixing portion 31, a second connection portion 32 and a plurality of second contact portions 23. The second fixing portion 31 is a curved plate. The second connection portion 32 protrudes from an inner side of the second fixing portion 31. The second connection portion 32 is used to connect an external neutral wire. The second contact portions 33 protrude from an outer side of the second fixing portion 31 and are spaced each other. The second contact portions 33 are respectively located in the second holes 106 of the insertion portions 104. Each second contact portion 33 includes two second arms 331 and a second is groove 301 defined between the two second arms 331. The second groove 301 has a front opening facing the second hole 106. The feet of an external plug are inserted through the second hole 106 and into the second groove 301, so that the feet of the external plug are electrically connected.

The LED illumination unit 40 comprises a circuit board 41 and at least one LED disposed on the circuit board 41. There are two LED illumination units 40 in this embodiment. The circuit board 41 of each LED illumination unit 40 is provided with a plurality of LEDs 42. The number of the LED illumination units 40 and the number of LEDs 42 on each LED illumination unit 40 are not limited. Each fixing trough 107 is provided with one LED illumination unit 40. The circuit board 41 of each LED illumination unit 40 is vertically inserted into the fixing trough 107. The LED 42 extends out of the fixing trough 107 to illuminate forward, providing an illumination effect.

The transformer 50 is secured on the main body 10. The transformer 50 is used to transform high-voltage power into low-voltage power so as to provide appropriate voltage to the LED illumination unit 40 during operation.

The outer casing 60 wraps the main body 10. The outer casing 60 has a fan shape. The outer casing 60 has a plurality of first insertion holes 61 and a plurality of second insertion holes 62. The plurality of first insertion holes 61 correspond in position to the first holes 105. The plurality of second insertion holes 62 correspond in position to the second holes 106. The outer casing 60 is waterproof and durable. The outer casing 60 is made of a transparent material, so that the light of the LED illumination unit 40 can pass the outer casing 60. The main body 10 and the LED illumination unit 40 are wrapped by the outer casing 60 to protect all the parts. The outer casing 60 comprises a power cord 601 which extends out from a rear end of the outer casing 60.

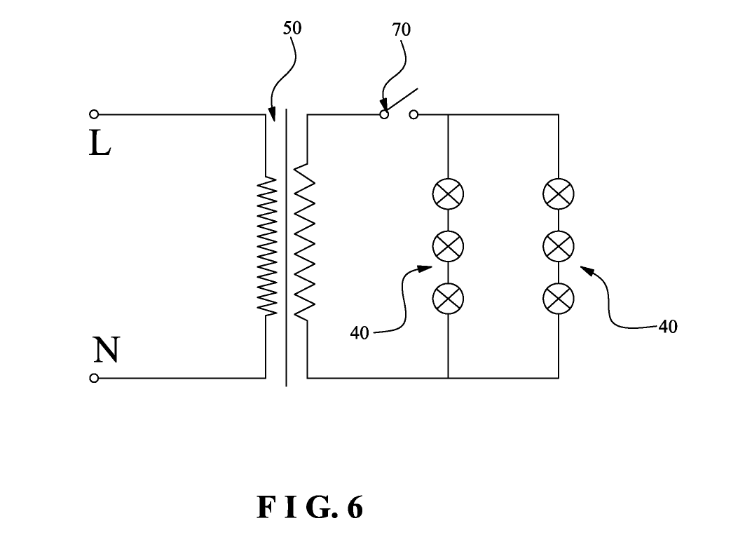

The switch 70 is used to control the LED illumination unit 40 to be turned on/off. The switch 70 is secured on the main body 10. As shown in FIG. 6, the switch 70, the LED illumination unit 40 and the transformer 50 are in a series connection. There are two LED illumination units 40 in this embodiment. The two LED illumination units 40 are in a parallel connection. The switch 70 is a button switch, and comprises an operation end 71 which is exposed out of the surface of the rear end of the outer casing 60. The LED illumination unit 40 is turned on/off by pressing the operation end 71.

The present invention further comprises an earth terminal 80. The earth terminal 80 includes a third fixing portion 81, a third connection portion 82 and a plurality of third contact portions 83. The third fixing portion 81 is a curved plate. The third fixing portion 81 is inserted in the insertion recess 103. The third connection portion 82 protrudes from an inner side of the third fixing portion 81. The third connection portion 82 is used to connect an external earth wire. The third contact portions 83 protrude from an outer side of the third fixing portion 81 and are spaced each other. Each third contact portion 33 is positioned on an upper surface of the main body 10 through an insulation block 90. The insulation block 90 is tightly clamped between the inner surface of the outer casing 60 and the outer surface of the main body 10. The insulation block 90 has a third hole 91 therein. The third hole 91 is located between the first hole 105 and the second hole 106. The third hole 91, the first hole 105 and the second hole 106 form a [symbol] -shaped configuration. The third contact portion 83 is located in the third hole 91. The front side of the outer casing 60 has a third insertion hole 63 corresponding in position to the third hole 91.

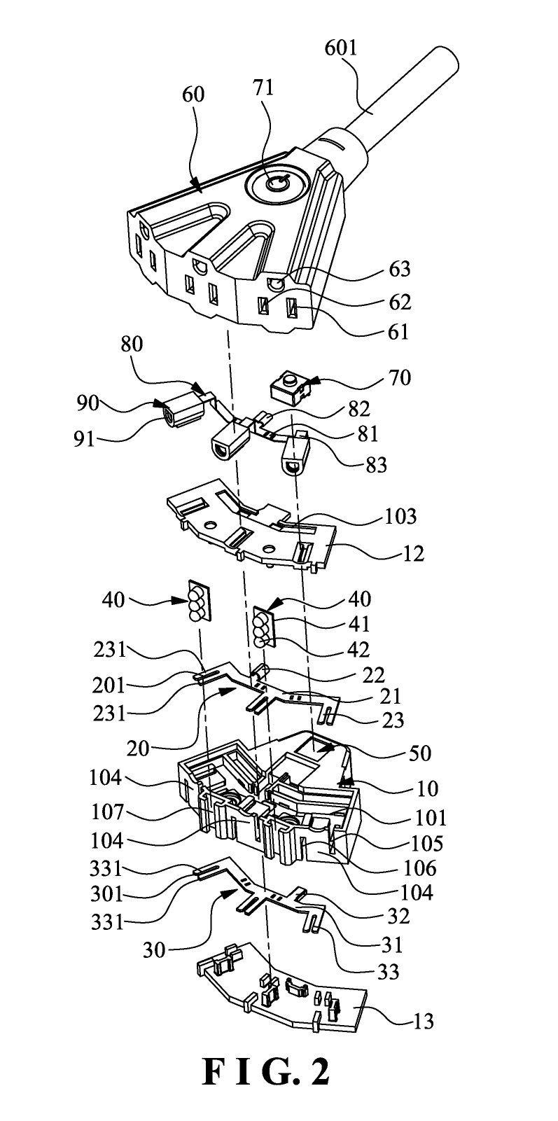

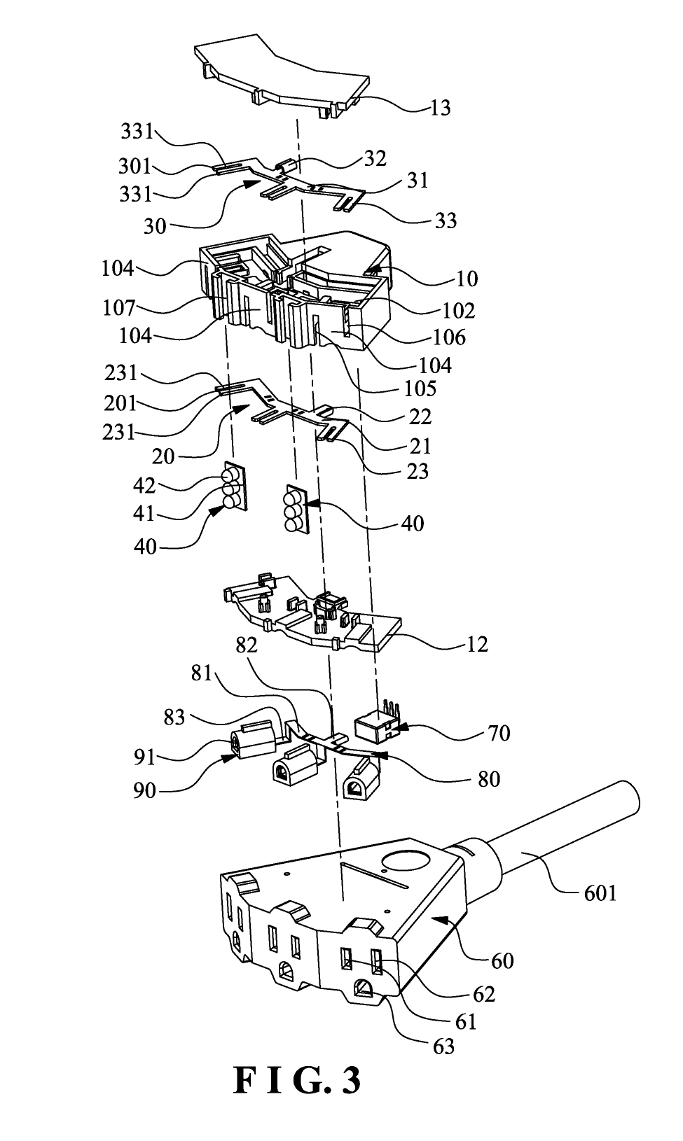

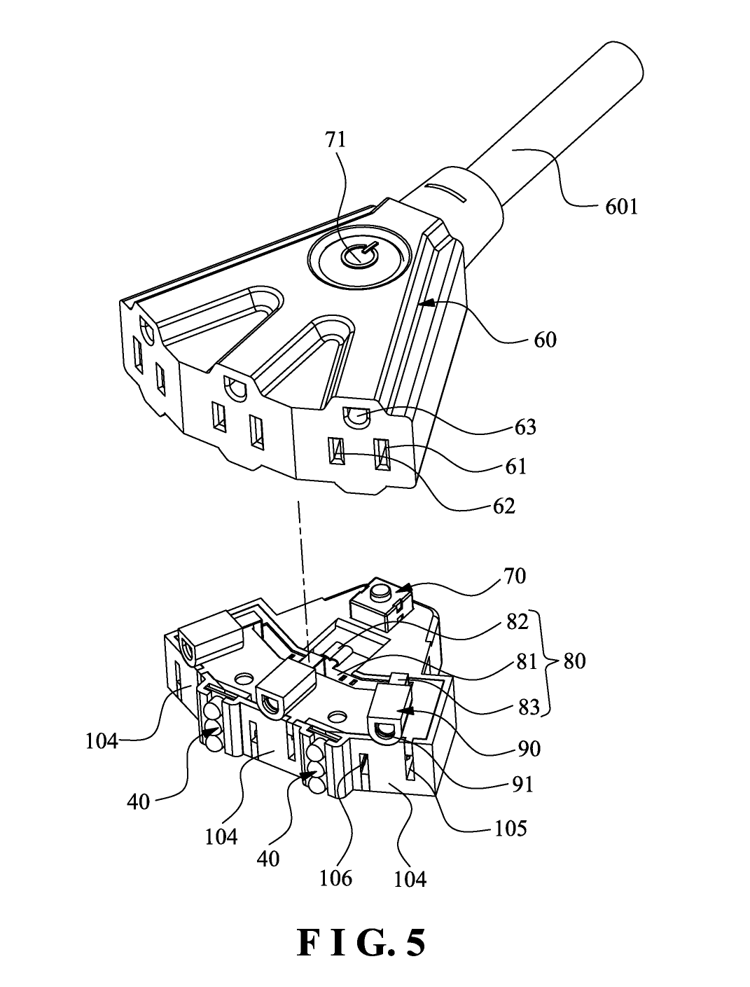

To assemble the present invention, as shown in FIG. 2 and FIG. 3, the live wire terminal 20 and the neutral wire terminal 30 are respectively inserted in the upper chamber 101 and the lower chamber 102 of the base 11, so that the first contact portions 23 of the live wire terminal 20 and the second contact portions 33 of the neutral wire terminal 30 are respectively located in the first holes 105 and the second holes 106. The upper lid 12 and the lower lid 13 cover the upper chamber 101 and the lower chamber 102 of the base 11, such that the live wire terminal 20 and the neutral wire terminal 30 are secured in the main body 10. Then, the circuit board 41 of each LED illumination unit 40 is inserted in the relative fixing trough 107 at the front side of the main body 10, so the circuit board 41 is secured in the relative fixing trough 107. The LEDs 42 extend out of the fixing trough 107 to illuminate forward. The LED illumination unit 40 is installed and secured well. After that, the transformer 50 is installed in the main body 10. The switch 70 is fixed on the main body 10. The transformer 50, the LED illumination units 40, and the switch 70 are in a series connection. The two LED illumination units 40 are in a parallel connection and controlled by the switch 70. The third fixing portion 81 of the earth terminal 81 is embedded in the insertion recess 103 of the main body 10. Each third contact portion 83 of the earth terminal 80 is positioned on the upper surface of the main body 10 through the insulation block 90, such that the earth terminal 80 is secured on the upper surface of the main body 10, as shown in FIG. 5. The outer casing 60 wrap the main body 10, the earth terminal 80, and the LED illumination units 40. The operation end 71 of the switch 70 is exposed out of the rear end of the outer casing 60. The first insertion holes 61, the second insertion holes 62 and the third insertion holes 63 of the outer casing 60 correspond to the first holes 105, the second holes 106 and the third holes 91 the insulation block 90. The present invention is completely assembled, as shown in FIG. 1.

When in use, the first connection portion 22 of the live wire terminal 20, the second connection portion 32 of the neutral wire terminal 30, and the third connection portion 82 of the earth terminal 80 are connected to an external live wire, an external neutral wire, and an external earth wire, respectively. The feet of the plug of an electric apparatus is inserted in the first insertion hole 61, the second insertion hole 62 and the third insertion hole 63. The foot inserted in the first insertion hole 61 is inserted through the first hole 105 and tightly clamped by the two first arms 231 of the first contact portion 23 of the live wire terminal 20 to achieve electric connection. The foot inserted in the second insertion hole 62 is inserted through the second hole 106 and tightly clamped by the two second arms 331 of the second contact portion 33 of the neutral wire terminal 30 to achieve electric connection. The foot inserted in the third insertion hole 63 is inserted through the third hole 91 and tightly clamped by the first contact portion 33 of the earth terminal 80 to achieve electric connection. At this time the electric apparatus is connected to the power source. When in a dark surrounding, the operation end 71 of the switch 70 is pressed down, so that the LED illumination units 40 are electrically connected to illuminate. The light of the LED illumination unit 40 emits forward, which is convenient for the user to look for the position of the insertion holes so as to connect the plug of the electric apparatus. The LED illumination unit 40 can function as a flashlight to provide illumination when at a dark environment.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An outdoor socket with lamp, comprising:
a main body comprising a base, an upper lid and a lower lid, the base having an upper chamber and a lower chamber on upper and lower sides thereof, the upper lid and the lower lid being adapted to cover the upper chamber and the lower chamber respectively, the main body having at least two insertion portions at a front side thereof, each of the insertion portions having a first hole and a second hole, the first hole communicating with the upper chamber, the second hole communicating with the lower chamber, the main body further having a fixing trough which is vertically disposed at the front side of the main body and located between the insertion portions;
at least one live wire terminal secured in the upper chamber, the live wire terminal having a first contact portion, the first contact portion being located in the first hole;
at least one neutral wire terminal secured in the lower chamber, the neutral wire terminal having a second contact portion, the second contact portion being located in the second hole;
at least one LED (light emitting diode) illumination unit comprising a circuit board and at least one LED disposed on the circuit board, the circuit board being vertically inserted into the fixing trough, the LED extending out of the fixing trough to illuminate forward;
a transformer secured on the main body;
an outer casing wrapping the main body, the outer casing having a first insertion hole and a second insertion hole, the first insertion hole and the second insertion hole respectively corresponding in position to the first hole and the second hole; and
a switch used to control the LED illumination unit to be turned on/off, the switch being secured on the main body, the switch, the LED illumination unit and the transformer being in a series connection, the switch comprising an operation end which is exposed out of a surface of a rear end of the outer casing.

2. The outdoor socket with lamp as claimed in claim 1, wherein the main body is in a fan shape, the main body having three insertion portions and two fixing troughs at the front side thereof, each of the fixing troughs being provided with one said LED illumination unit, the circuit board of the LED illumination unit being provided with a plurality of LEDs.

3. The outdoor socket with lamp as claimed in claim 2, wherein the upper chamber and the lower chamber are in a fan-shaped configuration, and the upper lid and the lower lid are fan-shaped plates.

4. The outdoor socket with lamp as claimed in claim 2, wherein the live wire terminal includes a first fixing portion, a first connection portion and a plurality of first contact portions, the first fixing portion being a curved plate, the first connection portion protruding from an inner side of the first fixing portion, the plurality of first contact portions protruding from an outer side of the first fixing portion and being spaced each other.

5. The outdoor socket with lamp as claimed in claim 4, wherein the first contact portion of the live wire terminal includes two first arms and a first groove defined between the two first arms, the first groove having a front opening facing the first hole.

6. The outdoor socket with lamp as claimed in claim 2, wherein the neutral wire terminal includes a second fixing portion, a second connection portion and a plurality of second contact portions, the second fixing portion being a curved plate, the second connection portion protruding from an inner side of the second fixing portion, the plurality of second contact portions protruding from an outer side of the second fixing portion and being spaced each other.

7. The outdoor socket with lamp as claimed in claim 6, wherein the second contact portion of the neutral wire terminal includes two second arms and a second groove defined between the two second arms, the second groove has a front opening facing the second hole.

8. The outdoor socket with lamp as claimed in claim 1, further comprising an earth terminal, the earth terminal including a third contact portion, the third contact portion being positioned on an upper surface of the main body through an insulation block, the insulation block having a third hole therein, the third hole being located between the first hole and the second hole, the third contact portion being located in the third hole, the front side of the outer casing having a third insertion hole corresponding in position to the third hole.

9. The outdoor socket with lamp as claimed in claim 8, wherein the earth terminal includes a third fixing portion, a third connection portion and a plurality of third contact portions, the third fixing portion being a curved plate, the upper lid having an insertion recess on an upper surface thereof, the third fixing portion being inserted in the insertion recess, the third connection portion protruding from an inner side of the third fixing portion, the plurality of third contact portions protruding from an outer side of the third fixing portion and being spaced each other.

10. The outdoor socket with lamp as claimed in claim 1, wherein the outer casing is made of a transparent material.
